(19) United States
(12) Patent Application Publication
(10) Pub. No.: US 2017/0286606 A1
(43) Pub. Date: Oct. 5, 2017

(54) APPARATUSES, METHODS, AND COMPUTER PROGRAM PRODUCTS FOR CUSTOMIZED PRICING OF CLAIMS FOR REIMBURSEMENT

(71) Applicant: Change Healthcare LLC, San Francisco, CA (US)

(72) Inventors: Marc Lassin, Warrington, PA (US); Michael Prissovsky, Chalfont, PA (US); Richard Fritzson, Paoli, PA (US); Debra Franklin, Gainesville, GA (US); David Russell, Lexington, MA (US)

(21) Appl. No.: 15/458,583

(22) Filed: Mar. 14, 2017

Related U.S. Application Data
(60) Provisional application No. 62/316,296, filed on Mar. 31, 2016.

(51) Int. Cl. G06F 19/00

(52) U.S. Cl. CPC G06F 19/328; G06F 19/3406

(57) ABSTRACT

Apparatuses, methods, and computer program products are provided for pricing claims for reimbursement within a claim pricing software application presented in a graphical user interface. In particular, a software application is described in which a processing logic for processing claims is visible to the user, and the user is able to interact with and manipulate various parts of the processing logic to develop customized payment methodologies that reflect payor-provider contractual relationships and negotiated terms for reimbursement. Accordingly, input is received from the user via input fields of the graphical user interface that define a payment methodology of the claims for reimbursement, where the input comprises selection of predefined code portions (including variables and functions) to define a customized payment methodology for pricing the claim.

### CROSS-REFERENCE TO RELATED APPLICATIONS

This application claims the benefit of U.S. Provisional Application No. 62/316,296 entitled “Apparatuses, Methods, and Computer Program Products for Customized Pricing of Claims for Reimbursement,” filed Mar. 31, 2016, the contents of which are incorporated herein in their entirety.

### BACKGROUND

In various industries, businesses often enter into contracts with each other that dictate pricing for the provision of goods and/or services to each other or to third parties. For example, one company (e.g., a service provider) may contractually agree to provide services to a third party (e.g., a consumer) according to a fixed rate schedule, where certain types of services have certain negotiated pricing. Another company (e.g., a payor) may contractually agree to pay for the services rendered by the service provider company to the third party at the negotiated rate. The pricing may vary depending on the contract terms, the third party to whom the goods or services are being rendered, the type of goods or services rendered, and various other factors.

### BRIEF SUMMARY

When goods or services are provided in such a scenario, payment must be rendered to the provider according to the terms of the contract between the provider, the payor, and/or the third party recipient of the goods or services. Contracts may vary, and the third party and/or the payor may often require an indication as to the amount that it will be required to pay to the provider for the goods or services rendered.

Accordingly, embodiments of the invention described herein provide improved apparatuses, methods, and computer program products for customized pricing of claims for reimbursement.

In particular, an application for use by a provider and/or a payor is provided that allows the user to define and/or modify a payment methodology for processing claims for reimbursement such that the payment can correspond with a particular contract for payment via a more intuitive and easy-to-use graphical user interface that allows the user to select from a number of predefined code portions. In this way, changes or updates to contract pricing may be more easily accommodated and implemented, and the requestor of payment information for goods or services rendered (e.g., the payor or the recipient) may be able to obtain up-to-date and accurate pricing information before or after the provision of the goods or services.

Accordingly, in some embodiments, a pricing engine core is provided that comprises at least one non-transitory computer-readable storage medium having computer-executable program code portions stored therein. The computer-executable program code portions comprises program code instructions for: receiving claim data comprising details of a claim for reimbursement; accessing a rate schedule, wherein the rate schedule comprises a codified representation of financial terms from a contract used to price the claim, wherein the rate schedule includes product data for one or more products; receiving selection of a product; and determining pricing of the claim for reimbursement based on the rate schedule accessed and the product selected.

Determining pricing of the claim may comprise accessing the product data of the rate schedule, iterating over and executing a list of active service categories based on the product data accessed from the rate schedule, wherein each service category specifies one or more service category criteria, and determining the matching service category of the claim by comparing each service category criteria of a respective service category to the claim data, wherein the matching service category determined further comprises one or more service groups and wherein each service group comprises service group criteria. Determining the pricing may further comprise executing the service group criteria for at least one of the service groups of the service category determined against the claim data to select an appropriate service group for the claim, determining a list of payment methodologies from the service group selected for the claim, and executing at least one of the payment methodologies determined to price the claim for reimbursement. The claim data may, in some cases, further comprise information provided by a payor relevant to the claim for reimbursement.

In some embodiments, a plurality of appropriate service groups may be selected via execution of the service group criteria, and determining the list of payment methodologies may further comprise determining a list of payment methodologies from each service group selected for the claim. Executing at least one of the payment methodologies determined may further comprise executing at least one of the payment methodologies determined for each service group selected to price the claim for reimbursement.

The computer-executable program code portions may, in some embodiments, further comprise program code instructions for compiling executable components of the rate schedule accessed, wherein the compiled code is used to determine pricing of the claim for reimbursement. Additionally or alternatively, the computer-executable program code portions may further comprise program code instructions for outputting to a user a priced claim for reimbursement and an explanation of components of the rate schedule accessed that is used to price the claim. In some cases, the computer-executable program code portions may further comprise program code instructions for outputting to the user an explanation of pricing for each line of the priced claim for reimbursement. Moreover, in some embodiments, the program code instructions for executing at least one of the payment methodologies determined to price the claim for reimbursement may further comprise program code instructions for determining line level pricing within a claim level pricing scheme.

In other embodiments, a computer-implemented method and/or computer program product are provided for developing a rate schedule for pricing claims for reimbursement within a claim pricing software application presented in a graphical user interface. The method and computer program product include providing for display of a first screen comprising an input field within a graphical user interface; receiving input from a user via the input field of the first screen comprising data identifying a rate schedule to be used for pricing a claim; receiving a selection from the user of a product; receiving a selection from the user of a service category of the claim; and providing for display of a second screen comprising an input field within the graphical user interface, wherein the input field of the second screen is configured to receive input from the user of criteria to be associated with the selected service category. The method and computer program product further include receiving selection from the user of a service group for the selected service category; providing for display of a third screen comprising an input field within the graphical user interface based on the service group selected; and receiving input from the user via the input field of the third screen defining a payment methodology of the claims, wherein the input from the user comprises selection of predefined code portions to define a customized payment methodology for pricing the claim and/or user-defined payment methodology.

In some cases, the predefined code portions may comprise portions of predefined domain specific language code that are independently selectable by the user. The predefined code portions may be displayed in a predefined area of the third screen for selection by the user, and selection of a predefined code portion from the predefined area may serve to populate the input field of the third screen with the selected predefined code portion. The predefined code portions may be combinable by the user to create a payment methodology capable of determining line level pricing within a claim level pricing scheme.

In some embodiments, the computer-implemented method and computer program product may further comprise receiving in a library a user-defined payment criterion for defining the payment methodology. The user-defined payment criterion may be stored in a library and may be accessible as a predefined code portion via at least one of the first screen, the second screen, the third screen, or a fourth screen of the graphical user interface for subsequent selections by the user for defining the payment methodology. The service group selected may be associated with a claim level pricing scheme or a line level pricing scheme.

In other embodiments, an apparatus is provided for pricing claims for reimbursement within a claim pricing software application presented in a graphical user interface. The apparatus comprises at least one processor and at least one memory including computer program code. The at least one memory and the computer program code are configured to, with the processor, cause the apparatus to at least provide for display of a first screen comprising an input field within a graphical user interface; receive input from a user via the input field of the first screen comprising data identifying a rate schedule to be used for pricing a claim; receive a selection from the user of a product; receive a selection from the user of a service category of the claim; and provide for display of a second screen comprising an input field within the graphical user interface, wherein the input field of the second screen is configured to receive input from the user of criteria to be associated with the selected service category. The at least one memory and the computer program code are also configured to, with the processor, cause the apparatus to receive selection from the user of a service group for the selected service category; provide for display of a third screen comprising an input field within the graphical user interface based on the service group selected; and receive input from the user via the input field of the third screen defining a payment methodology of the claims, wherein the input from the user comprises selection of predefined code portions to define a customized payment methodology for pricing the claim.

In some cases, the predefined code portions may comprise portions of predefined domain specific language code that are independently selectable by the user. The predefined code portions may be displayed in a predefined area of the third screen for selection by the user, and selection of a predefined code portion from the predefined area may serve to populate the input field of the third screen with the selected predefined code portion. The predefined code portions may be combinable by the user to create a payment methodology capable of determining line level pricing within a claim level pricing scheme.

The at least one memory and the computer program code, in some cases, may be further configured to, with the processor, cause the apparatus to receive, via at least one of the first screen, the second screen, the third screen, or a fourth screen of the graphical user interface, a user-defined payment criterion for defining the payment methodology. The user-defined payment criterion may be stored as a predefined code portion for subsequent selections by the user for defining the payment methodology.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic representation of an apparatus in accordance with one example embodiment of the present invention;

FIG. 2 is a schematic representation of a system environment in which the apparatus of FIG. 1 may operate in accordance with one example embodiment of the present invention;

FIG. 3 illustrates the flow of data with respect to a pricing engine core for determining claim pricing in accordance with one example embodiment of the present invention;

FIG. 4 is a simplified schematic representation of processing logic of the pricing engine core of FIG. 3 in accordance with one example embodiment of the present invention;

FIGS. 5-12 illustrate screens of a graphical user interface of a claim pricing software application in accordance with one example embodiment of the present invention;

FIG. 13 is a flow chart illustrating a method implemented by a pricing engine core for pricing claims for reimbursement in accordance with an example embodiment of the present invention; and

FIG. 14 is a flow chart illustrating a method for pricing claims for reimbursement within a claim pricing software application presented in a graphical user interface in accordance with an example embodiment of the present invention.

### DETAILED DESCRIPTION

Embodiments of the present invention now will be described more fully hereinafter with reference to the accompanying drawings, in which some, but not all embodiments of the invention are shown. Indeed, embodiments of this invention may be embodied in many different forms and should not be construed as limited to the embodiments set forth herein; rather, these embodiments are provided so that this disclosure will satisfy applicable legal requirements. Like reference numerals refer to like elements throughout.

Although the description that follows may include examples in which embodiments of the invention are used in the context of healthcare insurance claims by users at healthcare-related organizations, such as hospitals, pharmacies, and medical insurance companies, it is understood that embodiments of the invention may be applied to software applications used in numerous settings, including for other types of claims for reimbursement and by organizations outside the field of healthcare.

Software applications are generally used to help businesses in every sector carry out their operations. In scenarios where businesses enter into contracts with each other and with consumers, such as with respect to payment schemes for the provision of certain goods and services as described above, software applications may be used to determine pricing of those goods and services according to contracted rates.

In the context of healthcare, as an example, a healthcare provider (e.g., a doctor or hospital system) may enter into a contract with a medical insurance company, under which the medical insurance company (the payor) agrees to reimburse claims made by recipients (e.g., insured individuals) of medical goods or services (collectively, “services”) rendered by the healthcare provider. The terms of the contract may determine what types of services are covered by the contract, the settings in which they may be rendered (e.g., inpatient or outpatient), who may render the services (e.g., which doctors or hospitals), a negotiated price for the services, and so on.

As market and regulatory forces hasten the healthcare industry's journey to value-based care, payors are increasingly being tasked to support a complex, ever-changing mix of fee-for-service (FFS) and value-based reimbursement (VBR) payment models. Conventional software applications, systems, and tools for pricing claims are generally fixed and do not easily accommodate changes in payment methodologies that may occur due to modifications in pricing contracts or reimbursement innovations. Thus, using conventional claim pricing and reimbursement applications, a change in a claim pricing methodology based on a new or modified contract term, for example, may require costly custom configurations that require access to and high-level knowledge of the programming behind the claim pricing and reimbursement tool, and manual claim review and pricing are often necessitated. Such work-arounds and manual processing many times result in payment errors, require re-work, mandate increased staffing requirements, provide limited or no payment transparency, and significantly limit the ability of an organization to efficiently implement and automate new payment methodologies in the market.

As an example, some mainstream conventional claim pricing software applications are limited in their ability to allow a user to create complex service qualifiers that are used to determine claim pricing. Such applications may require complex implementation and pricing setup, and users may be required to access multiple applications to define pricing rules. In some cases, for example, users may need to use pointer IDs and cryptic pricing logic that includes non-intuitive acronyms to code pricing rules. Moreover, there may be limited multi-procedure payment reduction logic involved that is not able to make use of complex service qualifiers. The pricing under such conventional systems may be “canned” pricing that does not allow for the creation of new payment methodologies, and users may be required to upgrade their software (often at a cost) to receive new pricing rules or functionality. Such conventional claim pricing software applications thus provide little or no flexibility with respect to creating fee schedules and pricing tables, as the user has limited or no access to the claim data used in pricing.

Accordingly, embodiments of the present invention provide pricing engines, computer-implemented methods, apparatuses, and computer program products for pricing claims, such as healthcare claims, within a claim pricing application presented in a graphical user interface that address the complexities and limitations of the conventional solutions addressed above. In particular, embodiments of the invention provide a hierarchical structure and design of a rate schedule that is based on representing the financial arrangement outlined in a contract between a healthcare provider and insurance payor in a more straightforward manner that allows for certain elements to be compiled and executed by the pricing engine. Embodiments of the invention thus provide a claim pricing and reimbursement tool that is capable of supporting new complexities and developments in payor-provider relationships by using a rate schedule layout that is tailored to reflect the financial arrangement in a contract and a library of pricing components that can be easily configured by a user based on how the user's organization conducts business. In this way, embodiments of the invention offer the flexibility and scale to meet the ever-changing demands of the market.

As described in greater detail below, embodiments of the computer-implemented methods, apparatuses, and computer program products use intelligent business logic that includes customizable elements such as fee schedules, rate parameters, claim and non-claim data elements, and allow for the invocation of code written in a variety of payment methodology languages that can be used to calculate the contracted amount for reimbursing a claim. The embodiments described herein thus enable payment transparency and accuracy using auditing and validation tools, which offer agility that promotes innovation and automation to scale while reducing the total cost of ownership and increases speed to market of the software application.

In particular, embodiments of the invention described herein conform to the way contracts are structured; provide a mechanism for building out that structure in a user-friendly manner; use domain specific language (DSL) to facilitate claim pricing in the field of healthcare; allow users to create new payment methodologies via the DSL; allow users the ability to compile rate schedules into executable code that makes the pricing of claims more efficient than in conventional systems; allow users to configure the system to use local aliases to represent claim elements; and allow users to load fee schedules in any format, as dictated by the user's rules with support from the DSL.

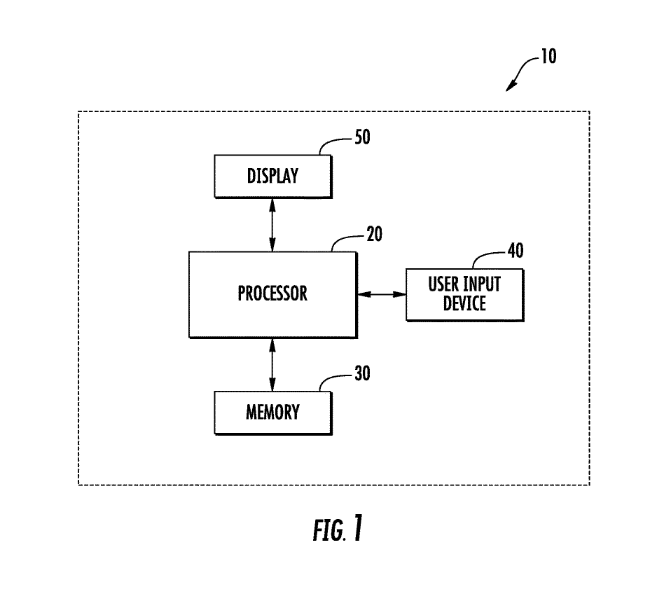

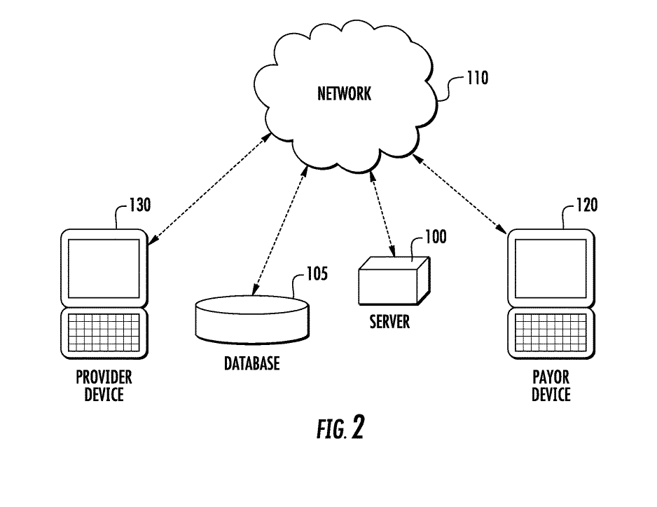

With reference now to FIG. 1, an apparatus 10 is illustrated for pricing a claim, such as a healthcare insurance claim, within a claim pricing application presented in a graphical user interface. The apparatus 10 may, in some embodiments, be a computer (e.g., a desktop computer, laptop computer, server, etc.) or other user device that includes hardware and software configured for receiving user input; accessing claim data, logic processing criteria, and payment methodologies; and enabling user creation of new or modified payment methodologies using predefined code portions for pricing claims, as described in greater detail below. In other embodiments, the apparatus 10 may be embodied as a chip or chip set. In other words, the apparatus 10 may comprise one or more physical packages (e.g., chips) including materials, components and/or wires on a structural assembly (e.g., a baseboard). The apparatus 10 may therefore, in some cases, be configured to implement an embodiment of the present invention on a single chip or as a single “system on a chip.”

In some embodiments, the apparatus 10 may comprise at least one processor 20, which may be embodied in a number of different ways. For example, the processor 20 may be a coprocessor, a microprocessor, a controller, or various other processing circuitry including integrated circuits. In some embodiments, the processor 20 may include one or more processing cores configured to perform independently. Additionally or alternatively, the processor 20 may include one or more processors configured in tandem via a bus to enable independent execution of instructions, pipelining and/or multithreading.

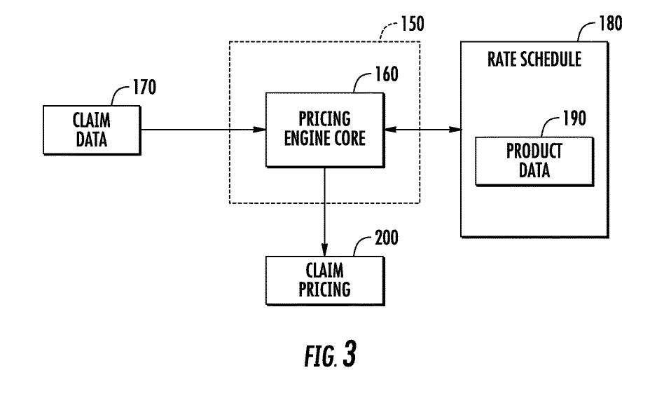

The apparatus 10 may further comprise at least one memory 30, and the processor 20 may be configured to execute instructions stored in the memory 30 or that are otherwise accessible to the processor. In embodiments in which the processor is embodied as an executor of software instructions, the instructions may specifically configure the processor to perform the algorithms and/or operations described herein when the instructions are executed. The memory 30, which may include volatile memory, such as volatile Random Access Memory (RAM) and/or non-volatile memory, may store any of a number of pieces of information and data, including software programs, libraries, databases, applications, repositories of data, files, etc. that are used by the apparatus 10 to implement the functions described herein. A memory 30 storing various types of data according to one embodiment is illustrated in FIG. 2 and described in greater detail below.

With continued reference to FIG. 1, the apparatus 10 may further include or be in communication with a user input device 40 and a display 50. The user input device 40 may be one or more of a keyboard, mouse, touchpad, touchscreen, etc., that is configured to receive input from a user and convey the input to the processor 20. The display 50 may be any computer output surface and/or projecting mechanism that is configured to show text and/or graphic images to the user, such as via cathode ray tube (CRT), liquid crystal display (LCD), light-emitting diode, gas plasma, or other image projection technology.

Referring to FIG. 2, for example, the apparatus 10 of FIG. 1 may, in some cases, be embodied by a server 100 (e.g., in a web-based system), where the server is in communication with one or more devices via a network 110. In the depicted embodiment, the devices include a payor device 120 and a provider device 130. In this regard, the payor device 120 and/or the provider device 130 may be computers, laptops, or other user terminals that are configured to run or have access to a claim pricing and reimbursement software application (e.g., an application running on the server 100) according to embodiments of the invention described herein. Thus a user (e.g., a payor user or a provider user) may use a payor device 120 or a provider device 130, respectively, to access and interact with embodiments of the claim pricing and reimbursement software via a graphical user interface (e.g., presented on the display 50) to price a claim. Moreover, authorized users may, according to some embodiments, provide inputs to the software application and otherwise interact with the graphical user interface of the software application to create and/or modify payment methodologies to price claims according to new or revised contracts, as described in greater detail below.

The system of FIG. 2 may further include a database 105 (which, in some embodiments, may be a database server including a processor and a memory) that is configured to store edited rate schedule information, as described in greater detail below.

The software application may be accessed from the server 100 by a user via the respective payor device 120 or provider device 130 at a respective user site (e.g., an insurance claim processing center or a hospital), and the software application may run on the payor device 120 or the provider device 130 or may otherwise generate a user interface that is presented at the respective device such that the user is able to view and interact with data presented at the respective user device. In this regard, the payor device 120 and/or the provider device 130 may be a computer, such as a laptop or a desktop computer, a tablet computer, or any other computing device comprising a display, a processor, and a memory, that a user can interact with to access, view, and manipulate data provided by the software application. For example, the user may, in some cases, access the software application through communication between the user device and the server 100 over the Internet or an intranet, such as via a webpage interface. The server 100 may in turn access data (such as edited rate schedule information) from the database 105 to execute functions requested via the payor and/or provider devices 120, 130.

In some embodiments, the claim pricing and reimbursement software application, as noted above, may comprise a software program (e.g., executable software consisting of compiled code that can run directly from a computer's operating system) that provides a specific group of functions to the user for, in the case of embodiments of the present invention, pricing claims and determining reimbursement amounts to be paid by the payor to a provider for services rendered to a recipient (e.g., a third party consumer of the services). The claim pricing and reimbursement software application may, in some cases, be structured as described in U.S. Pub. No. 2014/0278567 entitled “Determining Reimbursement Amounts Based on Reimbursement Models” and filed on Mar. 15, 2013, which is incorporated by reference herein.

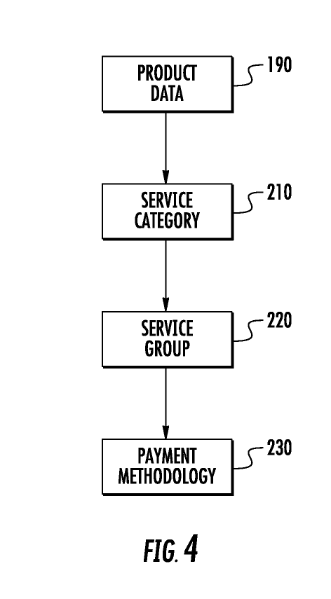

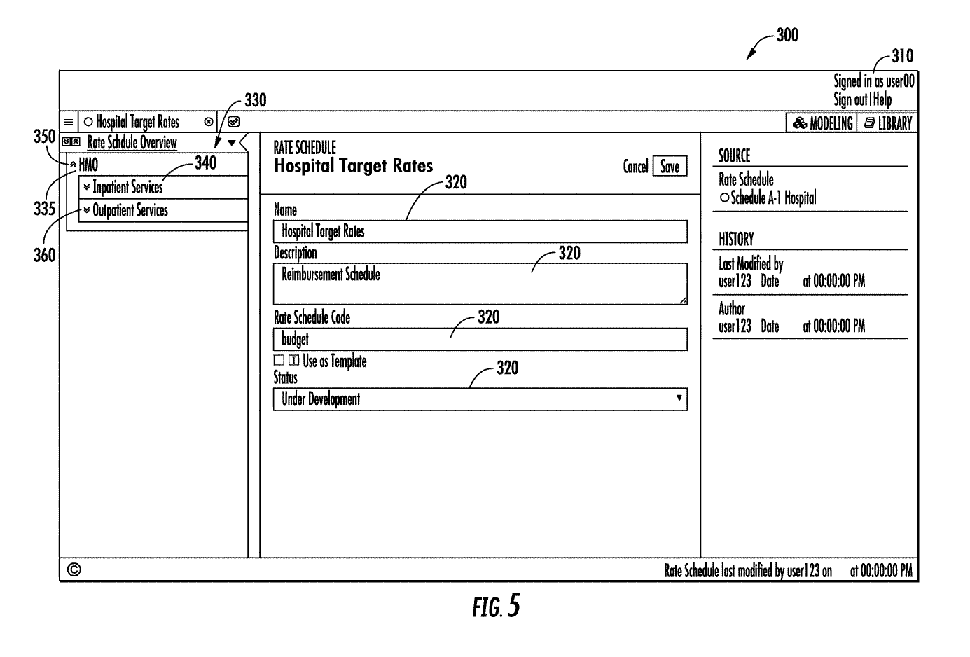

With reference now to FIG. 3, in some embodiments, the claim pricing and reimbursement software application 150 may comprise a pricing engine core 160. The pricing engine core 160 may comprise at least one non-transitory computer-readable storage medium having computer-executable program code portions stored therein, which may be one or more sets of code (e.g., written in Java or any other general purpose programming language). The computer-executable program code portions may comprise program code instructions configured to receive claim data input 170 and access a corresponding rate schedule 180 that includes product data 190 for one or more products for use by the pricing engine core 160 in determining claim pricing 200 based on processing logic defined in the rate schedule or otherwise accessible to the pricing engine core 160. In this regard, the claim data 170 that the pricing engine core 160 may receive as input from a user or the system may include various details of a claim for reimbursement, such as the insurance product in which the recipient of the goods or services is enrolled, the type of goods or services rendered, who rendered them and where, the date of the rendering and the date of the claim, and any other details required for processing of the claim. The claim data may, in some cases, further comprise information provided by a payor relevant to the claim for reimbursement (e.g., making it an “enhanced” claim).

The pricing engine core 160, in turn, may access an appropriate rate schedule 180 based on information provided in the claim data 170 (e.g., a code included in the claim data that identifies the correct rate schedule) for processing the claim. Rate schedules 180 may be described as a structured codified representation of all the financial terms from a contract that are used to price a claim. Each rate schedule 180 may in turn include product data 190 describing a contract product group or line of business typically used to associate a network of providers with a payor, such as an HMO (Health Maintenance Organization), PPO (Preferred Provider Organization), and so on. The rate schedule 180 identified in the claim data 170, which may be one of a plurality of active rate schedules that is available, may include information for a plurality of different products 190, and the appropriate product may be identified as part of the claim data 170, such as through the use of a product identifier in the claim data.

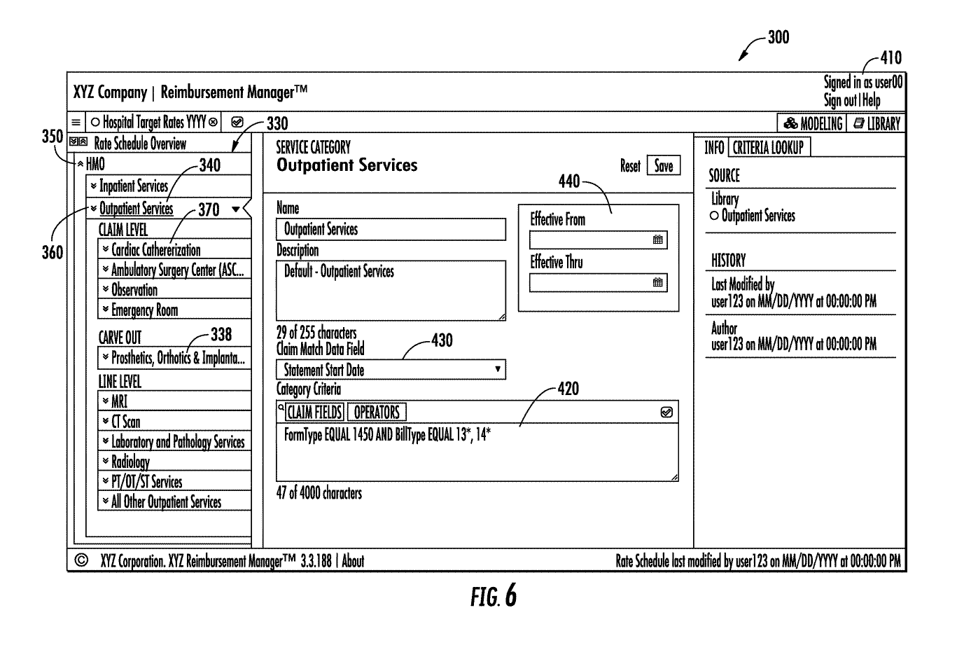

The pricing engine core 160 may use processing logic to determine pricing of the claim described by the claim data 170 based on the product data 190 found in the appropriate rate schedule 180 information that is accessed. A simplified processing logic flow diagram is illustrated in FIG. 4, in which, at the highest level, product data 190 is accessed to identify a list of active service categories 210. Service categories 210 refer to groupings of medical services based on the care setting where the services were rendered to a recipient. Examples of service categories 210 include “inpatient,” “outpatient,” “professional,” etc.

Each service category 210 identified in the product data 190 may in turn specify multiple service category criteria. Each of the service category criteria may be evaluated against the claim data 170, and in cases in which the criteria match, additional claim data may be accessed and evaluated. In this regard, claim data 170 may be provided as header level fields or as line level fields, depending on whether the claim is to be priced using claim level pricing or line level pricing techniques, as specified by the service group. According to claim level pricing methods, the overall clam is priced based on a single service group match plus any applicable matching carve outs, where carve outs are specific medical services rendered to a member that are contracted for reimbursement separately from other services under certain conditions (e.g., implants, high-cost drugs, etc.). Thus, under claim level pricing, it is not necessary to evaluate individual lines of the claim in order to calculate the price; however, in some embodiments as described below, pricing at the line level is allowed in a claim level pricing calculation according to embodiments of the present invention. According to line level pricing methods, the claim is priced based on a consideration and pricing of each line. Thus, although a line may be priced at $0, each line must nonetheless be priced to consider the overall claim successfully priced.

As service category criteria is evaluated against the claim data 170 (to determine the service category of the claim), if the criteria match, then it is determined whether a claim match date is a header level field. If this is the case and the corresponding claim header date field value is within the Service Category Effective From/Thru range, then the service category is selected and the analysis continues to the service group level. If the claim match data is a line level field and the corresponding claim line date field value is within the Service Category Effective From/Thru range for all lines, the service category is selected and the analysis proceeds to service groups. If no service category is selected for any reason, then the claim is pended.

Next down on the hierarchy of processing logic in FIG. 4 are service groups 220. Service groups 220 are categories of specific medical services rendered to a member and represented on a claim for reimbursement. Examples include “Office Visit,” “Emergency Room Visit,” “Surgery,” etc.

For each claim level service group specified in the selected service category (e.g., a service group that is to be priced using claim level pricing), the service group criteria for that service group is executed against the claim data 170 to identify the appropriate service group for the claim. The execution of the service group criteria may include iterating over each line in the claim and/or evaluating the criteria against the combination of claim header fields and current claim line fields. If the criteria match for the given service group, a list of carve outs that apply to the selected service group is retrieved and processed. The carve outs may be evaluated using line level processing techniques, for example. As such, the service group criteria may be executed within the compiled code (e.g., the compiled rate schedule).

A list of payment methodologies 230 may then be determined from the service group selected for the claim (e.g., where the list of payment methodologies is retrieved from the selected service group). A payment methodology 230 may be described as the payment logic necessary to calculate reimbursement for a specific service as outlined in the contract between the provider and the payor. Examples may include “Per Diem,” “Case Rate,” “Percent of Billed Charges,” etc. Each payment methodology 230 may be executed, such as by stepping through the payment logic of the given payment methodology to price the claim. In some cases, the claim may be priced by assigning a total allowed amount to the claim, whereas alternatively or additionally individual lines of the claim may be assigned a line allowed amount. Any errors encountered while stepping through the payment methodology may serve to pend the claim. The group pricing may thus be calculated as being equal to the total allowed amount plus the sum of all line allowed amounts. Moreover, if carve outs are priced, they would be included in separate groups and added to the overall allowed amount for the claim.

If there are no claim level service groups in the rate schedule that match the claim data, then the claim may be priced using line level pricing. Accordingly, a list of line level service groups may be retrieved from the matching service category, and for each line level service group the service group criteria may be evaluated against all remaining unpriced lines of the claim. For each line of the claim data 170 that matches the service group criteria, the line is tested to ensure that the line is unpriced. If the line is indeed unpriced, the payment methodology 230 for the service group is retrieved and evaluated for the given line (e.g., by stepping through the payment logic for a line and assigning a line allowed amount value). If the line has already been priced by a previous iteration, it would be skipped and the process would continue to the next matched line. The group price would be calculated as equal to the sum of all line allowed amounts priced under the given service group.

Once all line level service groups have been evaluated, if all of the lines have been priced, processing of the claim ends and the overall allowed amount for the claim will be the sum of all group prices. If, however, any unpriced lines of the claim data 170 remain, then those lines and the overall claim would be pended.

Accordingly, as described above with respect to FIGS. 3 and 4, each product is uniquely identified in the product data 190 of the rate schedule 180 by a name and is matched to the product name submitted on the claim 170. Under each product is one or more service categories 210, each with its own claim match date field and “effective from” date defined. An “effective through” date may in some cases also be defined. Each service category 210 may include a criteria expression that comprises a claim field term, EQUAL or NOT EQUAL operators, valid codes for the claim field expressed as either a single value, list of values, range of values, or wildcarded values, and optionally AND/OR logical operators that are used to create compound expressions with more than one claim field term.

Each service category 210 may in turn be associated with one or more service groups 220, and each service group may include its own criteria expression defined in the same format as the respective service category 210, although different claim fields may be used. As noted above, a service group 220 may be categorized as a claim level service group, a line level service group, or a carve out. As such, a plurality of appropriate service groups may be selected via execution of the service group criteria, and determining the list of payment methodologies may comprise determining a list of payment methodologies from each service group selected for the claim. At least one of the payment methodologies determined for each service group selected may be executed to price the claim for reimbursement.

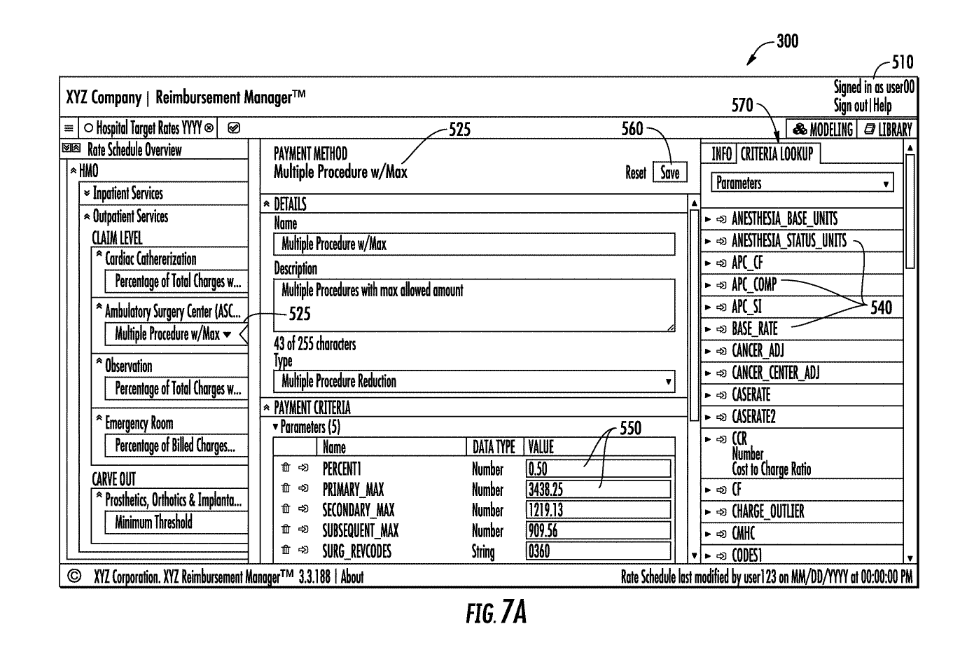

In this regard, each service group 220 may include one or more payment methodologies 230, and each payment methodology may include payment criteria written as an executable block of DSL code, as described above. Domain-specific language (DSL) may be defined as an extension of certain basic general purpose language operations and may allow the user to write criteria based on referencing claim fields, code values, fee schedule names and columns that are imported into the system (such as via a user interface configured to receive inputs, as described below with reference to FIGS. 5-12), parameters defined within the payment methodology as placeholders for separately entered numeric/alphanumeric/date/percentage values, and a list of functions and variables that are custom tailored to support the logic necessary for the given application (e.g., healthcare claim reimbursement). Examples of DSL that may be used in embodiments of the invention described herein are detailed in Appendix A.

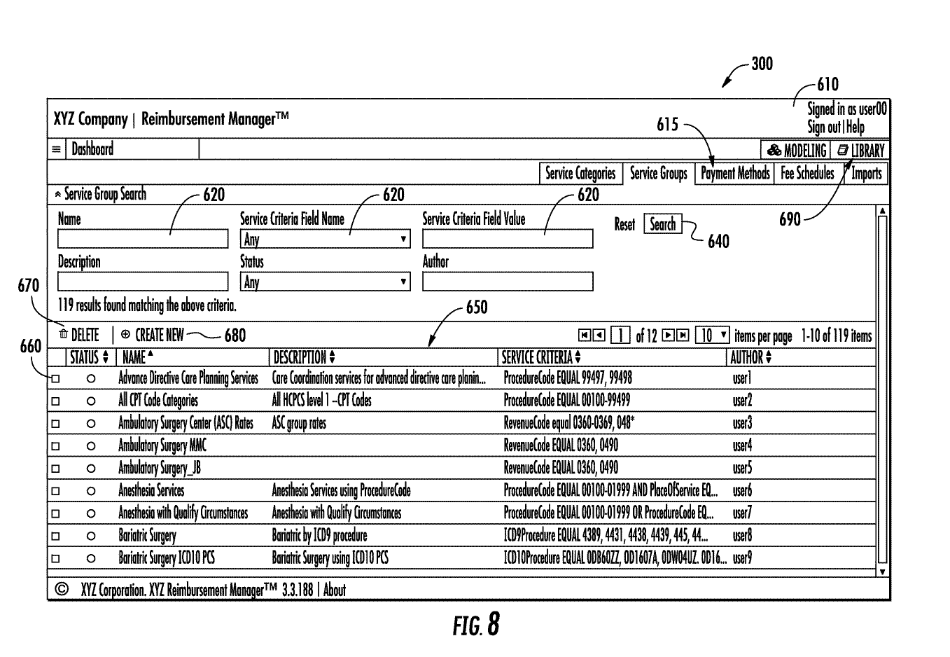

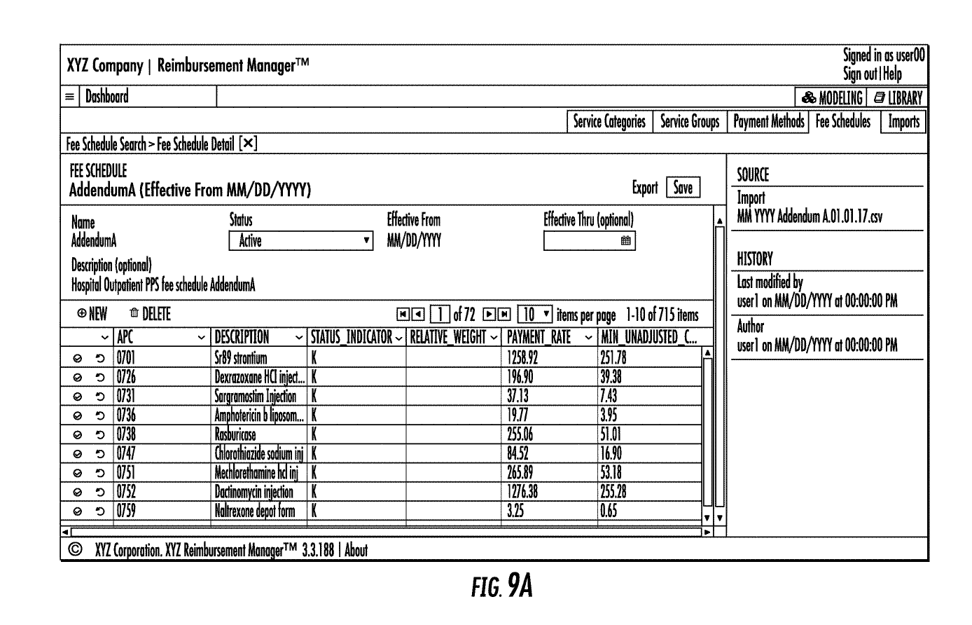

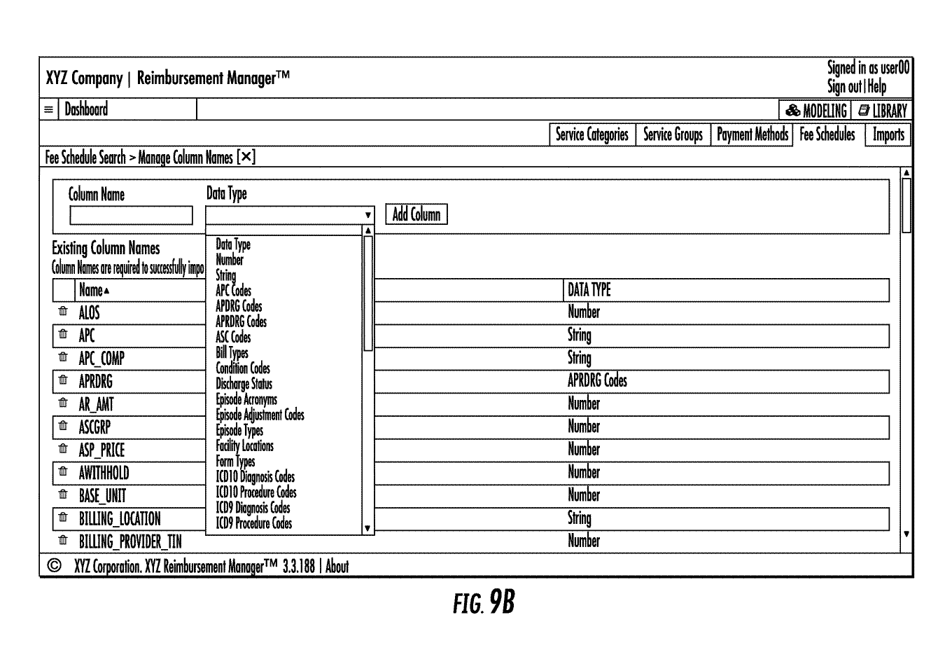

In this regard, according to some embodiments, a user interface may be provided, as described below with reference to FIGS. 5-12, for allowing the user to define the afore-mentioned criteria associated with service categories 210, service groups 220, and/or payment methodologies 230 for use by the pricing engine core 160, and the user interface may be, for example, a form of an integrated development environment (IDE). The user interface may be built on top of a 3^{rd} party Javascript library in some embodiments, such as the Ace library, and may allow for auto-completion of typed text, syntax highlighting, line numbering, and a custom built criteria lookup panel guiding the user to Help content and allowing for auto-insertion of terms or functions into the criteria, as described below. Accordingly, as described herein, embodiments of the present invention provide a more full exposure of the logic used to match and price a claim and thus allow the user to custom define any logic necessary to price a claim based on a contract using the service category, service group, and payment methodology criteria. Moreover, with respect to FIGS. 8-9B, a separate Library section may be provided in some embodiments in which commonly used and/or standard definitions of service categories, service groups, and/or payment methodologies can be created and stored and are subsequently accessible for creating a rate schedule.

The processing logic and hierarchy described above with respect to FIGS. 3 and 4 are implemented by the pricing engine core 160 shown in FIG. 3. The programming of the core, in some embodiments as noted above, may be written in Java or other general purpose language, and the core 160 may be designed to use a pre-fetched user-customizable mapping of criteria term names to claim data elements to determine if there is a match. After a product is selected, for example, the pricing engine core 160 may compile all of the executable components underneath it (e.g., service category criteria, service group criteria, payment methodology criteria, and payment methodology parameters) into executable code. In some cases, the compilation may already be done, and the pre-compiled object may be fetched from an in-memory cache for more efficient processing, such as when an edited, compiled rate schedule already exists and is stored on and accessible via the database 105 shown in FIG. 2. Moreover, as an example, in some embodiments, the ability to compile the logic into an executable file may rely on the same mapping of criteria term names to claim data elements represented within Java from the JSON-formatted claim submitted to the pricing engine core 160. This ability may also rely on proper syntax and usage of the domain-specific language.

In order to allow the pricing engine core 160 to process claim data 170 using a rate schedule 180, where the underlying contract or reimbursement methodology has been changed, embodiments of the present invention thus provide a graphical user interface that allows a user to create and/or modify a payment methodology 230 used in the processing logic of the pricing engine core 160. Examples of various screens of a graphical user interface 300 are illustrated in FIGS. 5-12 which thus allow a user to view the processing logic and payment methodology 230 that can be used by the pricing engine core 160 and further allow the user to interact with, manipulate, and create payment methodologies that accommodate new or changed contracts associated with the rate schedules 180.

Accordingly, embodiments of an apparatus for pricing claims for reimbursement within a claim pricing software application presented in a graphical user interface 300 (shown in FIGS. 5-12) is provided. The apparatus, which may be the apparatus 10 shown in FIG. 1, may comprise at least one processor 20 and at least one memory 30 including computer program code. The at least one memory 30 and the computer program code may be configured to, with the processor, cause the apparatus 10 to at least provide for display of a first screen 310 comprising an input field (or fields) 320 within a graphical user interface 300, as shown in FIG. 5. The first screen 310 may, for example, include an input field 320 for the user to enter a name or type of facility of the payor or provider, another input field for the user to enter a description of the payment methodology to be created or modified, another input field for the user to enter a code or other identifier associated with the particular rate schedule to be accessed for creating or modifying the payment methodology, and another input field for the user to input a status of the payment methodology (such as “under development”), as illustrated in FIG. 5. The input fields 320 may, in some cases, require the user to input text into the field (e.g., via a keyboard), whereas in other cases, the input fields may provide a drop down box, buttons, or other graphical user interface elements to allow the user to select from one or more available options to provide the input.

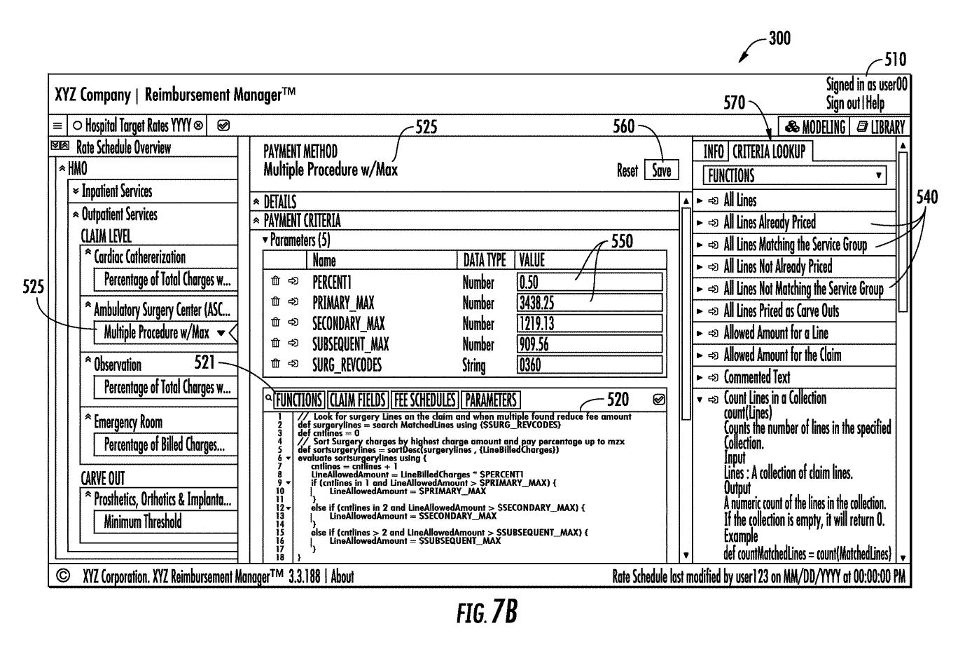

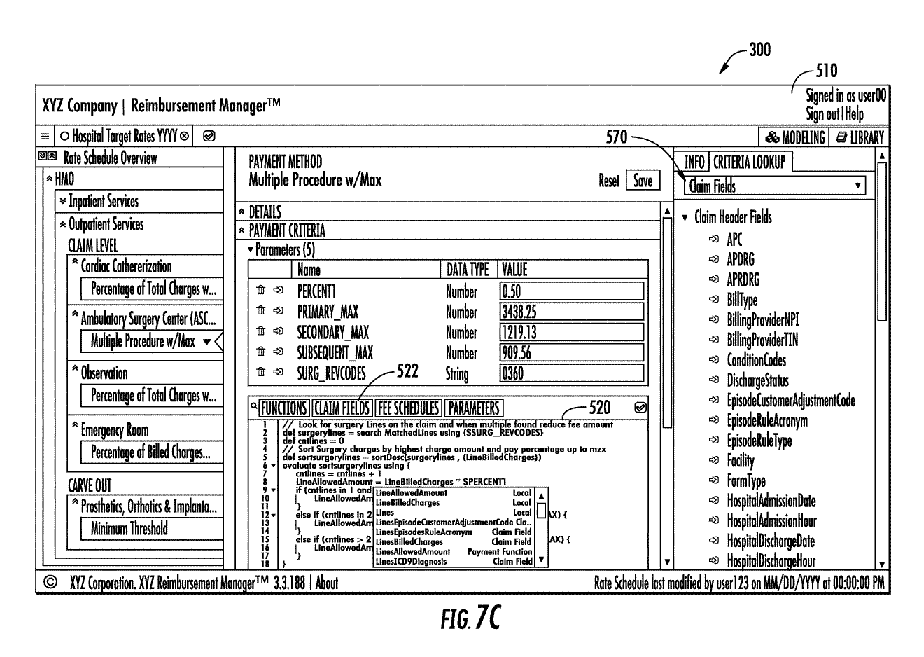

The first screen 310 may further include, in some embodiments, an area 330 comprising a listing of products 335 (e.g., insurance products, such as “commercial” versus “Medicare”), and the user may be able to view a listing of service categories 340 under each product, such as by clicking a product-level expand button 350. Each service category 340, in turn, may, in some embodiments, be expanded by clicking a service category-level expand button 360 to provide a list of claim level service groups 370 and carve out service groups 380, shown in FIG. 6. For example, the user may choose to expand the service groups under the service category “Outpatient Services” in FIG. 5, and the claim level and carve out service groups 370, 380 may be displayed as shown in FIG. 6. In this way, the user may, by expanding the products 335 and service categories 340 displayed in the area 330 of the first screen 310, be able to get an overview of the hierarchical structure and processing logic for pricing a particular claim for reimbursement and may, in this way, be better able to create or modify the associated payment methodology and related criteria.

Accordingly, the at least one memory and the computer program code may be configured to, with the processor, cause the apparatus to receive input from the user via the input field 320 of the first screen 310 (FIG. 5) identifying a rate schedule to be used for pricing a claim (e.g., via the rate schedule code input). As noted above, the apparatus may be caused (via the processor) to provide for display of a second screen 410 (FIG. 6) comprising an input field 420 within the graphical user interface 300, wherein the input field of the second screen is configured to receive input from the user of criteria to be associated with the selected service category (e.g., a desired service category selected from the displayed service categories in the area 330 or from a new service category). Additional input fields may be provided on the second screen 410, including fields for the user to select a desired claim match date field 430 and to enter effective from/through dates 440 for the pricing scheme. The at least one memory and the computer program code may further be configured to, with the processor, cause the apparatus to receive selection from the user of a service group for the selected service category, such as when a claim level service group 370 or a carve out service group 380 is selected by the user from the area 330. In other cases, the at least one memory and the computer program code may be configured to, with the processor, cause the apparatus to receive input from the user that creates a new service group for the selected service category. For example, user input may be received via a Library (accessed via button 690 shown in FIG. 8) of the application to define a new service category or service group. The new Library service category or service group may be activated, then added to the respective rate schedule. Alternatively, an existing service category or service group may be added and then modified by the user as needed to customize its use to a particular rate schedule. In any event, the service group 370, 380 that is selected or input may be associated with a claim level pricing scheme or a line level pricing scheme.

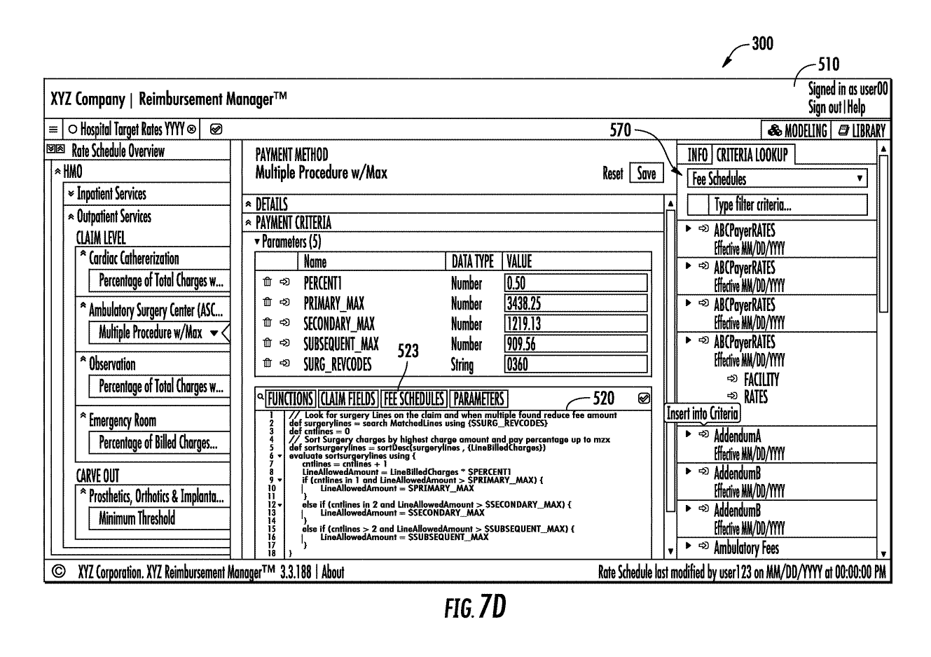

The apparatus may further be caused (via the processor) to provide for display of a third screen 510 comprising an input field 520 within the graphical user interface 300 based on the service group selected 525, as shown in FIGS. 7A-7B, where FIG. 7B is a continuation (scrolled down portion) of the interface illustrated in FIG. 7A. The at least one memory and the computer program code may further be configured to, with the processor, cause the apparatus to receive input from the user via the input field 520 of the third screen 510 defining a payment methodology of the claims, wherein the input from the user comprises selection of predefined code portions 540 to define a customized payment methodology for pricing the claim. In some cases, however, the user may write code directly in the input field 520 for creating the payment methodology, in addition to or instead of selecting predefined code portions 540. Regardless, the predefined code portions 540 may include variables and functions for defining the logic (e.g., code) for the desired payment methodology. For example, predefined code portions 540 comprising variables may be assigned values by the user via additional input fields 550, as illustrated in FIGS. 7A-7B, and these parameters may be included in the payment methodology that is created. The payment methodology may be saved by the user by clicking a “save” button 560, as shown. In this way, the newly defined payment methodology may be saved and accessed by the computer application (e.g., by the pricing engine core 160) at the appropriate point in the processing logic (see FIGS. 3 and 4) to price a claim based on a pricing contract that the payment methodology implements.

In some embodiments, the predefined code portions 540 may comprise portions of predefined code that are independently selectable by the user. For example, with reference to FIGS. 7A-7B, the predefined code portions may be displayed in a predefined area 570 of the third screen 510 for selection by the user, and selection of a predefined code portion from the predefined area may serve to populate the input field 520 of the third screen with the code of the selected predefined code portion.

For example, with reference to FIG. 7A, a list of parameters may be displayed in the predefined area 570 (which may be a criteria lookup panel, as illustrated), and the parameters, which may be based on the configuration of the Library of the application, may be selected and defined (via user input in the corresponding input fields 550) to build the payment criteria of the payment method. A list of domain specific language functions (“Functions”), shown in FIG. 7B, may be displayed in the predefined area 570 upon the user's selection of a “Functions” button 521 to allow the user to further define or modify the payment method.

In some embodiments, the user may also select claim header or claim line fields for use in creating the payment methodology. For example, FIG. 7C illustrates the list of currently configured claim header fields for creating payment methodologies that may be displayed to the user in the area 570, such as in response to the user's selection of a “Claim Fields” button 522. Moreover, a user's input of data in the input field 520 may be auto-completed as the user is typing, based on stored terms and functions. Similarly, as shown in FIG. 7D, the user may also select fee schedules and their corresponding column names for use in creating a payment methodology. For example, fee schedules for creating payment methodologies may be imported into and accessed from the Library of the application and, the list of available fee schedules and their corresponding column names may be displayed to the user in the area 570, such as in response to the user's selection of a “Fee Schedules” button 523. In some embodiments, a syntax highlighting feature may be provided. For example, this feature may provide for all domain specific language functions to be displayed in one color (e.g., blue); all claim fields to be displayed in a different color (e.g., red); etc. to provide a visual, color-coded indication of the different types of elements forming the payment methodology. Other features, values, descriptions, functions, etc. may be available, such as by accessing payment methods in the Library, to facilitate a user's creation or modification of a payment methodology, as will be understood by one skilled in the art in view of the present disclosure.

In some embodiments, the predefined code portions 540 may be combinable by the user to create a payment methodology capable of determining line level pricing within a claim level pricing scheme. For example, if a claim level service group 525 is selected by the user, a payment methodology may be created through selection of predefined code portions 540 that considers both claim level pricing and further evaluates individual lines of the claim, using a line-level pricing logic.

In some cases, in addition to receiving the user's selection of a predefined code portion 540 (such as from a list of predefined code portions displayed in a predefined area 570 in FIGS. 7A-7D), the at least one memory and the computer program code may be further configured to, with the processor, cause the apparatus to receive, a user-defined payment criterion for defining the payment methodology, such as by creation of a payment criterion by the user within the Library. For example, in FIGS. 7A-7B, the user may be able to select a predefined code portion 540 from the area 570, and the selected payment code portion may populate the input field 520 in which the payment methodology is being defined, which may then be adjusted or modified by the user within the input field 520. The resulting payment methodology may be saved to a Library for subsequent re-use or modification in the same or different rate schedule. Additionally, however, the user may also be able to manually input and save a payment criterion and/or payment methodologies (e.g., by typing code) directly into the Library for future access via user interfaces similar to those illustrated in FIGS. 7A-7D to create the desire payment methodology 530. Thus, the user-defined payment criterion may be stored in the Library as a predefined code portion for subsequent selections by the user for defining the payment methodology 530 (or a future payment methodology).

Turning to FIG. 8, embodiments of the software application for pricing claims for reimbursement may comprise a search screen 610, via which multiple aspects of the claim pricing logic may be searched. For example, tabs 615 may be provided for searching within service categories, service groups, and payment methodologies in a Library. Under the service groups search tab shown in FIG. 8, for example, input fields 620 may be provided for entering or selecting values for search criteria, such as the name of the service group, service criteria field name, service criteria field value, description, status, and/or author. Results of the search may be displayed in a results portion 650 of the window upon selecting a “Search” button 640 to initiate the search. The user may then be able to select a service group (e.g., by selecting the name of the service group displayed in the results portion 650) and create or modify the associated payment methodology; delete the service group and its associated payment methodology (e.g., by selecting a check box 660 for the given service group and actuating the “Delete” button 670; and/or create new service groups if the desired service group is not displayed, such as by selecting the “Create New” option 680. Moreover, a Library 690 of fee schedules and imports may be accessible through the corresponding tabs 615.

With reference to FIG. 9A, selecting the “Fee Schedules” tab 615 in FIG. 8, for example, may display the details of a Fee Schedule “Addendum A” (listed in the area 570 of FIG. 7D), which is one of the fee schedules that may be selected by the user for creating a payment methodology. From this screen, the user may be able to configure and manage the list of standard fee schedule columns, as well as available data types, as shown in FIG. 9B.

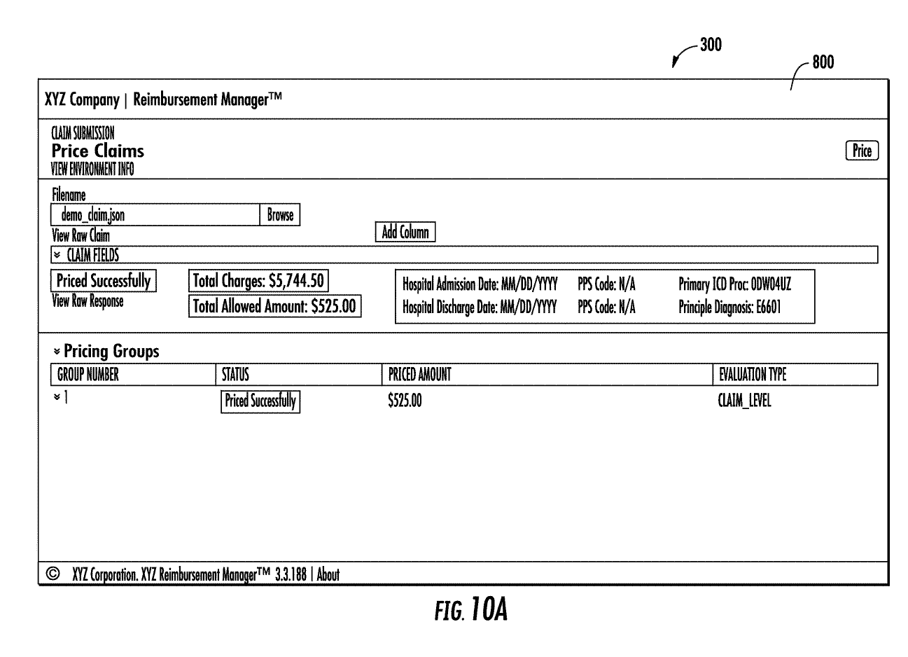

Turning now to FIGS. 10A and 10B, in some embodiments, the software application described above may output to the user a priced claim for reimbursement and an explanation of components of the rate schedule that is accessed and used to price the claim. For example, the computer-executable program code portions may further comprise program code instructions for outputting to the user a priced claim for reimbursement (e.g., a priced response 800) via the graphical user interface 300, which may be provided along with an explanation of components of the rate schedule accessed that is used to price the claim. Thus, the graphical user interface may integrate with the pricing engine core to allow the user to define and send claim data for reimbursement and then display the pricing response returned by the pricing engine core. The information may include an indication of whether the claim was successfully priced (or, for example, pended), the total charges, the total allowed amount, and/or the type of evaluation that was performed (e.g., line level versus claim level). In FIG. 10B, for example, the computer-executable program code portions further comprise program code instructions for outputting to the user an explanation of each pricing group returned in the response, where each pricing group contains the lines of the priced claim for reimbursement, such as in area 810.

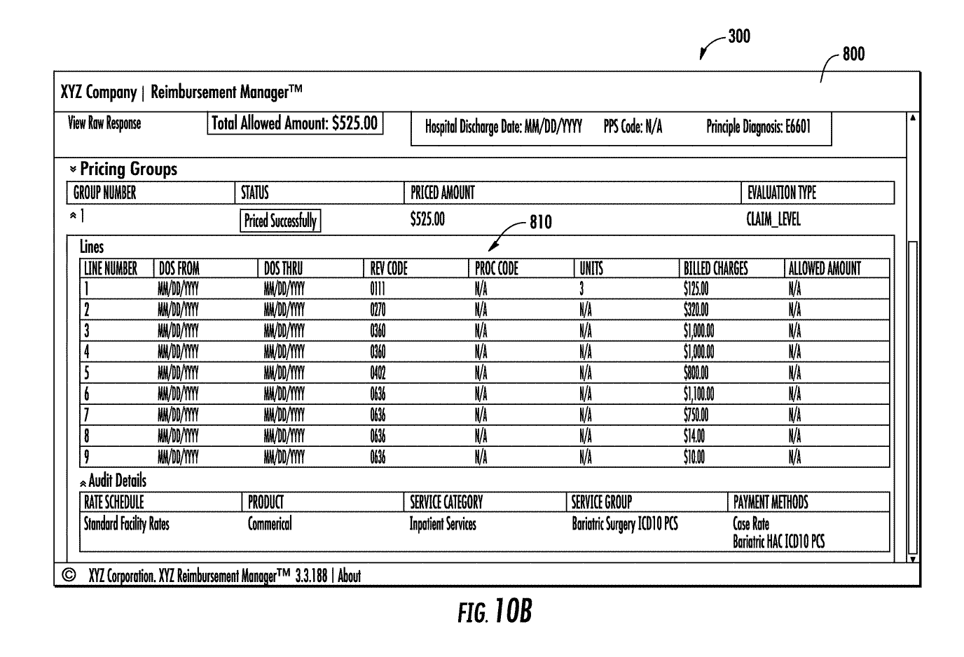

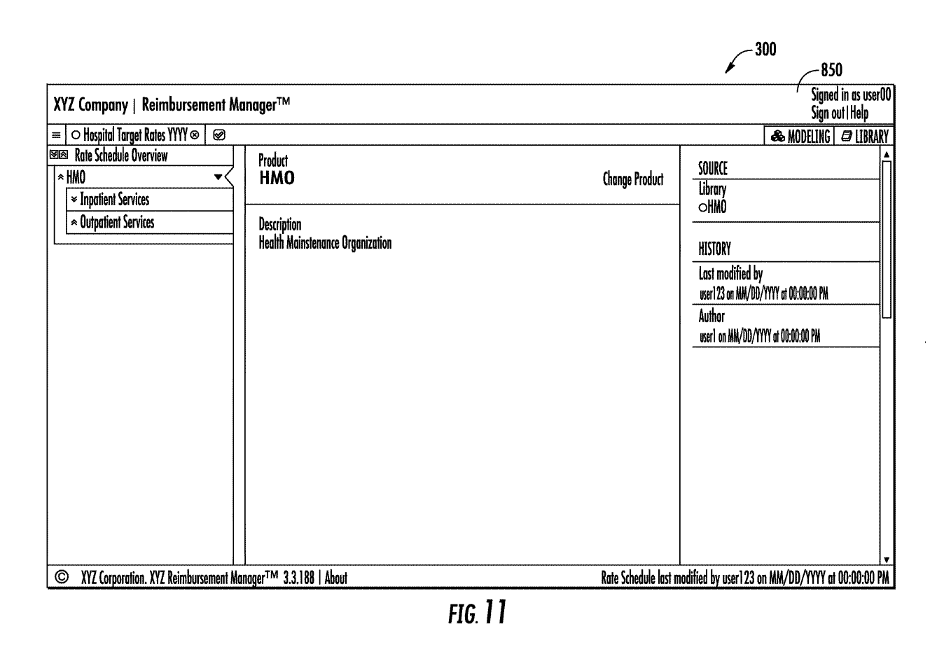

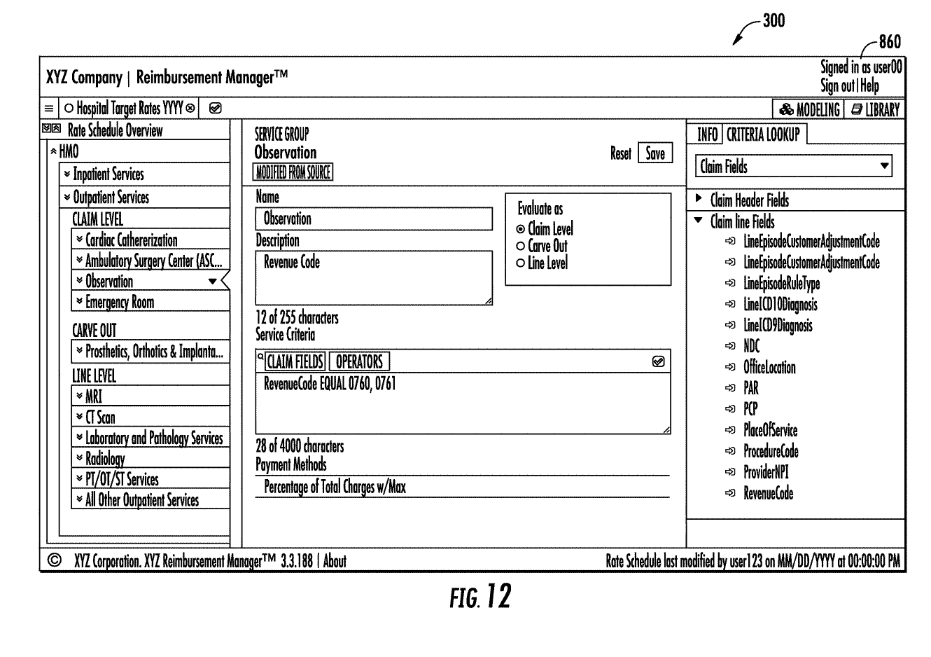

Other screens and functionality of the graphical user interface may be provided according to embodiments of the present invention to allow the user of the system more flexibility to provide inputs, adjust parameters, and view information regarding claims to be priced for reimbursement, as well as already priced claims. In FIG. 11, for example, a product screen 850 is shown within a rate schedule (where, in this example, the product is an HMO), such as for allowing a user to select a product, as described in greater detail above; in FIG. 12, a service group screen 860 is shown, along with a list of currently configured claim-line fields for the services groups, which may allow the service group criteria to be more easily configured by the user. Thus, the criteria lookup panel, described above, may in some cases be applicable to service categories and service groups as a way to guide the user in creating service category and service group criteria, similar to how it may be used with respect to payment criteria, as described above in connection with FIGS. 7A-7D.

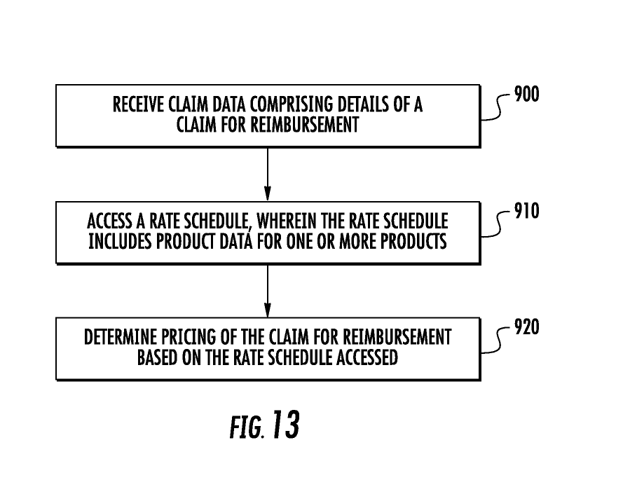

Referring now to FIG. 13, embodiments of a method implemented by the pricing engine core is depicted, as described above. According to embodiments of the method, claim data is received comprising details of a claim for reimbursement at Block 900, and a rate schedule is accessed at Block 910. Pricing of the claim for reimbursement is determined based on the rate schedule accessed at Block 920, where the pricing is determined by accessing the product data of the rate schedule, identifying a list of active service categories based on the product data accessed from the rate schedule, and determining the service category of the claim by comparing each service category criteria of a respective service category to the claim data. The service group criteria for at least one of the service groups of the service category determined may be executed against the claim data to select an appropriate service group for the claim, and a list of payment methodologies may be determined from the service group selected for the claim. At least one of the payment methodologies determined may be executed to price the claim for reimbursement, as described above.

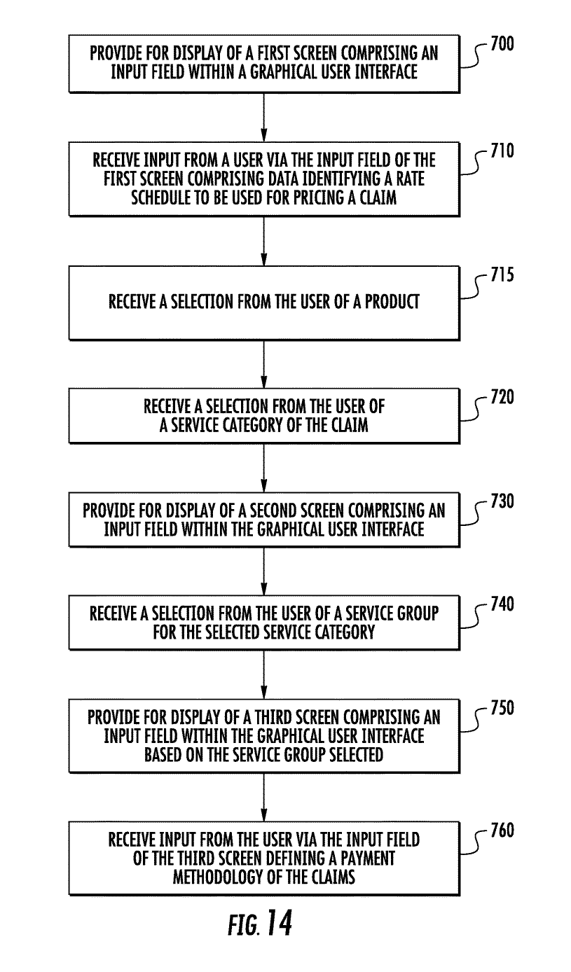

Referring now to FIG. 14, embodiments of a computer-implemented method for pricing claims for reimbursement within a claim pricing application presented in a graphical user interface are provided. According to embodiments of the method, display of a first screen comprising an input field within a graphical user interface is provided for at Block 700, and input is received from a user via the input field of the first screen comprising data identifying a rate schedule to be used for pricing a claim at Block 710. A selection is received from the user of a product at Block 715, and a selection is received from the user of a service category of the claim at Block 720. Display of a second screen comprising an input field within the graphical user interface is provided for at Block 730, wherein the input field of the second screen is configured to receive input from the user of criteria to be associated with the selected service category, and a selection is received from the user of a service group for the selected service category at Block 740. Display of a third screen comprising an input field within the graphical user interface is provided for based on the service group selected at Block 750, and input is received from the user via the input field of the third screen defining a payment methodology of the claims at Block 760, wherein the input from the user comprises selection of predefined code portions to define a customized payment methodology for pricing the claim. The service group selected may be associated with a claim level pricing scheme or a line level pricing scheme, as described above.

In some embodiments, the predefined code portions comprise portions of predefined code that are independently selectable by the user, as described above, to create or modify an existing payment method. The predefined code portions may be displayed in a predefined area of the third screen for selection by the user, and selection of a predefined code portion from the predefined area may serve to populate the input field of the third screen with the selected predefined code portion to create or modify an existing payment method.

In some cases, the predefined code portions may be combinable by the user to create a payment methodology capable of determining line level pricing within a claim level pricing scheme. Moreover, in some embodiments, a user-defined payment criterion may be created and stored (e.g., in a Library) for future selection by the user via at least one of the first screen, the second screen, the third screen, or a fourth screen of the graphical user interface for defining the payment methodology. The user-defined payment criterion may thus be stored as a predefined code portion for subsequent selections by the user for defining the payment methodology.

Example embodiments of the present invention have been described above with reference to block diagrams and flowchart illustrations of methods, apparatuses, and computer program products. In some embodiments, certain ones of the operations above may be modified or further amplified as described below. Furthermore, in some embodiments, additional optional operations may be included. Modifications, additions, or amplifications to the operations above may be performed in any order and in any combination.

It will be understood that each operation, action, step and/or other types of functions shown in the diagrams (FIGS. 13 and 14), and/or combinations of functions in the diagram, can be implemented by various means. Means for implementing the functions of the flow diagram, combinations of the actions in the diagrams, and/or other functionality of example embodiments of the present invention described herein, may include hardware and/or a computer program product including a non-transitory computer-readable storage medium (as opposed to or in addition to a computer-readable transmission medium) having one or more computer program code instructions, program instructions, or executable computer-readable program code instructions stored therein.

For example, program code instructions associated with FIGS. 13 and 14 may be stored on one or more storage devices, such as a memory 30 of the apparatus 100, and executed by one or more processors, such as processor 20, shown in FIG. 1. Additionally or alternatively, one or more of the program code instructions discussed herein may be stored and/or performed by distributed components, such as those discussed in connection with the apparatus 10. As will be appreciated, any such program code instructions may be loaded onto computers, processors, other programmable apparatuses or a network thereof from one or more computer-readable storage mediums to produce a particular machine, such that the particular machine becomes a means for implementing the functions of the actions discussed in connection with, e.g., FIGS. 13 and 14 and/or the other drawings discussed herein. As such, FIGS. 13 and 14 showing data flows may likewise represent program code instructions that may be loaded onto a computer, processor, other programmable apparatus or network thereof to produce a particular machine.

The program code instructions stored on the programmable apparatus may also be stored in a non-transitory computer-readable storage medium that can direct a computer, a processor (such as processor 20) and/or other programmable apparatus to function in a particular manner to thereby generate a particular article of manufacture. The article of manufacture becomes a means for implementing the functions of the actions discussed in connection with, e.g., FIGS. 13 and 14. The program code instructions may be retrieved from a computer-readable storage medium and loaded into a computer, processor, or other programmable apparatus to configure the computer, processor, or other programmable apparatus to execute actions to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel by one or more machines, such that multiple instructions are retrieved, loaded, and/or executed together. Execution of the program code instructions may produce a computer-implemented process such that the instructions executed by the computer, processor, other programmable apparatus, or network thereof provides actions for implementing the functions specified in the actions discussed in connection with, e.g., the processes illustrated in FIGS. 13 and 14.

Accordingly, as described above and with respect to the figures, embodiments of the invention provide systems and methods for allowing users to price claims in a more intuitive, user-friendly manner, while still allowing claims to be priced efficiently with respect to processing power. Payment methodologies are written in a domain specific language that allows the user to develop rules for determining how a claim should be reimbursed. This domain specific language supports traditional programming concepts including the definition of temporary variables, mathematical and logical assignment expressions using these temporary variables and claim and claim line elements, flow of control expressions using logical expressions composed of temporary variables and claim and claim line elements, logical operators, and user specified values. The language also supports the invocation of predefined functions for the pricing of the claim without the need for the user to write code that examines multiple claim lines and/or skips lines that have already been priced within the pricing method. These functions are presented to the user via a user interface as described herein that allows the user to insert one of the predefined functions into the payment methodology code. This predefined list is filtered based on the context of the language statement being processed and the prefix of the function being typed by the user.

The domain specific languages thus allow users to utilize user-specific names to represent the claim and claim line elements. Furthermore, the user may specify the value sets (e.g., code values and descriptions) to be used for each of the claim elements, with warning provided when claim elements are used in a logical comparison, if the values used in the comparison are not part of the user specified value set for the user named claim element.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### APPENDIX A—Payment Method Domain-Specific Language

There are numerous elements defined within the DSL offered by the product, best described as Variables and Functions. In addition to these custom elements, there are several standard Groovy operations supported.

### Standard

Commented Text—Specify a comment using either // or /* */
Define a Variable—Use “def” to define your own variable within the criteria
For Loop—Use “for (e in list) {<statements operating on each element of list>}” to apply a set of logic over multiple elements
If/Else If/Else—Use standard “if”, “else if”, “else” conditional logic to apply certain statements based on matching conditions
And/Or/Not—Use “and”, “or”, “not” as abstraction for the typical operator syntax for this logic In—Use “in” with conditional logic validating the presence of code values for a claim field, allowing the user to specify a single value, list of values, range of values, and wildcarded values.
Switch Statement—Use standard “switch (variable) {case . . . default}” conditional logic to apply certain statements based on matching the given case

### Variables

### AllLines

Returns all claim lines present in the claim, in the same order.
Value of this variable never changes during the claim processing, irrespective of Claim Level or Line Level pricing.
This is a read-only variable within the payment method and gets initialized to all claim lines at the beginning of processing each claim.

### CarveOutLines

Returns all lines that were matched and priced successfully by CarveOut service groups during Claim Level pricing.
This variable returns an empty list in payment methods of Line Level or CarveOut service groups.
Value of this variable never changes once set, i.e., after processing all CarveOut service groups.
This is a read-only variable within the payment method and gets initialized to empty list at the beginning of processing each claim.

### CurrentLine

When used explicitly in a payment method, outside of “evaluate lines using payment-block” DSL, this variable returns the line for which the payment method is being executed for a Line level or a CarveOut service group. So, value of this variable never changes across payment methods of the matched service group when used explicitly.
Within the “evaluate lines using payment-block” DSL, this variable returns the line for which the payment-block is being executed. So, value of this variable keeps changing for each line in this context.
This variable returns null in the payment method of Claim level service group.
This is a read-only variable within the payment method and gets initialized to null at the beginning of processing each claim.

### MatchedLines

Returns all lines that were matched to the current service group, irrespective of Claim Level, Line Level or Carve Out type.
Value of this variable never changes until all payment methods in the current matched service group executed.
Value of this variable will be changed immediately after matching a service group.
This is a read-only variable within the payment method and gets initialized to empty list at the beginning of processing each claim.

### PricedLines

Returns all lines that were processed till the time of accessing this variable.
In payment method of a Claim level service group, this variable returns all lines that were processed via “evaluate lines using payment-block” DSL till now. So, value of this variable keeps changing after each line is processed in the DSL.
In payment method of a Line level or Carve out service group, this variable returns all lines that were previously processed either by other service groups or by previous payment methods within this service group till now. In the context of “evaluate lines using payment-block” DSL, same behavior holds true as mentioned for Claim level service group above.
This is always calculated as AllLines-UnpricedLines
This is a read-only variable within the payment method and gets initialized to empty list at the beginning of processing each claim.

### UnmatchedLines

Returns all those lines that are not processed yet and not matched to the current service group, irrespective of Claim Level, Line Level or Carve Out type.
Value of this variable never changes until all payment methods in the current matched service group executed.
Value of this variable will be changed immediately after matching a service group.
This is a read-only variable within the payment method and gets initialized to empty list at the beginning of processing each claim.

### UnpricedLines

Returns all lines that were not processed till the time of accessing this variable.
Value of this variable may change within and for each payment method being executed if any new lines are being processed.
This is a read-only variable within the payment method and gets initialized to empty list at the beginning of processing each claim.

### TotalAllowedAmount

This variable can be read and modified in the payment method of a Claim Level service group. Value should be a number.
Any value assigned to this variable in the payment method of a non-Claim Level service group will be ignored.
This variable will be initialized to null at the beginning of processing each claim.

### LineAllowedAmount

This variable can be read and modified in a payment method of any service group. Value should be a number.
In payment method of a Claim Level service group, this variable should be used only within the “evaluate lines using payment-block” DSL. Changes to this variable will have no effect outside of this DSL.
In payment method of a Line Level or CarveOut service group, this variable can be used either explicitly or within the “evaluate lines using payment-block” DSL. When used explicitly, this variable refers to the allowed amount of the line being processed. Within the “evaluate lines using payment-block” DSL, this variable refers to the allowed amount of the line for which the payment-block is being executed.

### LOS

This variable returns the duration between Hospital Admission date and Hospital Discharge date provided in the claim.
If admission and discharge dates are same, this variable returns 1.
This is a read-only variable and its value will never change during the claim processing.

### Note—Processed Line:

A line is said to be processed if it is either priced or pended.
A line is considered priced by assigning a value to LineAllowedAmount variable either
   explicitly in one of the payment methods of a matched Line level service group AND all of the payment methods executed successfully without any errors.
   or via “evaluate . . . using . . . ” DSL AND there is no error produced while evaluating the line.
A line is considered pended when an error occurs while executing the payment method or when it never matched to any service group or no value set to LineAllowedAmount variable ever.

### Functions

### Search

Usage: search lines using {condition}
This function allows to search a set of lines based on a condition.
Ex: search AllLines using {LineAllowedAmount>100} will return those lines whose LineAllowedAmount is greater than 100.

### Evaluate

Usage: evaluate lines using {payment-block} OR evaluate line using {payment-block}
This function executes the payment-block for given line(s).
Note: If a line is already priced by a different service group than the current service group then that line will be ignored for re-pricing by this function.
Ex: evaluate UnmatchedLines using {LineAllowedAmount=200} will price all unmatched lines with amount of 200.

### Lookup

Usage: lookup columnName1, columnValue1, columnName2, columnValue2 . . . using FeeScheduleName
This function will try to match an active Fee Schedule whose name matches the given FeeScheduleName and whose column names and values matches the given columnName*, columnValue* pairs. At most one columnValue* reference may be a list, for which the lookup will return a row based on the first matching value encountered in the list. It also verifies if the claim match date falls within the Effective and Expiration dates of the Fee Schedule. If matched, it returns the matched Fee Schedule row as Map with columnName as key and columnValue as value.

### Note:

If a Fee Schedule cannot be found by the given name and claim date, an error will be thrown.
If there are multiple rows matching the columnName*, columnValue* pairs, an error will be thrown.
If there are is no matching row, an empty Map will be returned.
   Ex: lookup “PROC_CODE”, ICD9PrimaryProcedure using “FS” will return a Map based on the logic described above.

### Sort

Usage: sortAsc(lines, {variable1}, {variable2}, {variable3} . . . ) OR sortDesc(lines, {variable1}, {variable2}, {variable3} . . . )

This function returns lines which are sorted by the provided variables either ascending or descending. First variable will be used for sorting and other variables will be used when there are conflicts to sort.

Note: These functions will return empty list if empty lines are provided.
Ex: sortAsc(AllLines, {LineAllowedAmount}, {LineBilledCharges}) will sort all claim lines based on LineAllowedAmount and LineBilledCharges in ascending order.

### Group

Usage: groupAsc(lines, {variable1}, {variable2}, {variable3} . . . ) OR groupDesc(lines, {variable1}, {variable2}, {variable3} . . . ) This function groups given lines whose variables has same value and returns a List of grouped lines.
Note: These functions will return empty list if empty lines are provided.
Ex: groupAsc(AllLines, {LineAllowedAmount}, {LineBilledCharges}) will first sort given lines in ascending order and then group lines whose LineAllowedAmount and LineBilledCharges are same.

### Sum

Usage: sum(lines, {variable})
This function returns the sum of variables for all the lines.
Note: This function returns 0 if empty lines are provided.
Ex: sum(AllLines, {LineAllowedAmount}) will return sum of LineAllowedAmount for all lines.

### Count

Usage: count(lines)
This function returns the total number of given lines.
Ex: count(AllLines) will return total number of lines.

### Duration

Usage: duration(fromDate, toDate, type)
This function returns the duration(number of days or years) between from and to dates. The returned value depends on the given type(“days”, “years”).

### Note:

This function throws error if type doesn't match “days” or “years”.
This function throws error if fromDate and toDate are not provided or they are not in the “yyyyMMdd” format.
   Ex: duration(“20010901”, 20010905″, “days”) returns 4. Diagnosis Present on Admission

### Duration in Hours

Usage: duration(startDate, endDate, startHour, endHour)
This function returns the duration in hours between start and end date/times.

### Note:

This function throws error if startHour and endHour are not in 24-hour format (0-23).
This function throws error if startDate and endDate are not provided or they are not in the “yyyyMMdd” format.
   Ex: duration(“20010901”, 20010903”, 12, 15) returns 51.

### Diagnosis Present on Admission

Usage: diagnosisPOA(codeValue, POAValue)
This function returns true if the specified diagnosis code value and POA value are found together within the set of diagnosis/POA codes on the claim header, otherwise it returns false.
Ex: diagnosisPOA(“K9501”,“N”) will return true if the claim header Diagnosis code list has value “K9501” with its POA set to “N” otherwise it will return false.

### Round

Usage: round(value, scale, direction)
This function rounds a value to the specified number of decimal places based either on default rounding logic or the specified direction. The optional direction argument can specify to always round up or always round down, otherwise default rounding logic will round up or down to the nearest neighbor or up if both neighbors are equidistant.

### Note:

This function throws error if direction is specified and is anything other than ROUND_UP or ROUND_DOWN.
   Ex: round(4.3, 0) returns 4 and round(4.3, 0, ROUND_UP) returns 5.

What is claimed is:

1. A pricing engine core comprising at least one non-transitory computer-readable storage medium having computer-executable program code portions stored therein, the computer-executable program code portions comprising program code instructions for:
receiving claim data comprising details of a claim for reimbursement;
accessing a rate schedule, wherein the rate schedule comprises a codified representation of financial terms from a contract used to price the claim, wherein the rate schedule includes product data for one or more products;
receiving selection of a product; and
determining pricing of the claim for reimbursement based on the rate schedule accessed and the product selected, wherein determining pricing of the claim comprises:
accessing the product data of the rate schedule,
executing a list of active service categories based on the product data accessed from the rate schedule, wherein each service category specifies one or more service category criteria,
determining the service category of the claim by comparing each service category criteria of a respective service category to the claim data, wherein the service category determined further comprises one or more service groups and wherein each service group comprises service group criteria,
executing the service group criteria for at least one of the service groups of the service category determined against the claim data to select an appropriate service group for the claim,
determining a list of payment methodologies from the service group selected for the claim, and
executing at least one of the payment methodologies determined to price the claim for reimbursement.

2. The pricing engine core of claim 1, the claim data further comprises information provided by a payor and/or provider relevant to the claim for reimbursement.

3. The pricing engine core of claim 1, wherein a plurality of appropriate service groups are selected via execution of the service group criteria, wherein determining the list of payment methodologies further comprises determining a list of payment methodologies from each service group selected for the claim, and executing at least one of the payment methodologies determined further comprises executing at least one of the payment methodologies determined for each service group selected to price the claim for reimbursement.

4. The pricing engine core of claim 1, wherein the computer-executable program code portions further comprise program code instructions for compiling executable components of the rate schedule accessed, wherein the compiled code is used to determine pricing of the claim for reimbursement.

5. The pricing engine core of claim 1, wherein the computer-executable program code portions further comprise program code instructions for outputting to a user a priced claim for reimbursement and an explanation of components of the rate schedule accessed that is used to price the claim.

6. The pricing engine core of claim 5, wherein the computer-executable program code portions further comprise program code instructions for outputting to the user an explanation of pricing for each line of the priced claim for reimbursement.

7. The pricing engine core of claim 1, wherein the program code instructions for executing at least one of the payment methodologies determined to price the claim for reimbursement further comprises program code instructions for determining line level pricing within a claim level pricing scheme.

8. A computer-implemented method for pricing claims for reimbursement within a claim pricing software application presented in a graphical user interface, the method comprising:
providing for display of a first screen comprising an input field within a graphical user interface;
receiving input from a user via the input field of the first screen comprising data identifying a rate schedule to be used for pricing a claim;
receiving a selection from the user of a product;
receiving a selection from the user of a service category of the claim;
providing for display of a second screen comprising an input field within the graphical user interface, wherein the input field of the second screen is configured to receive input from the user of criteria to be associated with the selected service category;
receiving selection from the user of a service group for the selected service category;
providing for display of a third screen comprising an input field within the graphical user interface based on the service group selected; and
receiving input from the user via the input field of the third screen defining a payment methodology of the claims, wherein the input from the user comprises selection of predefined code portions to define a customized payment methodology for pricing the claim.

9. The computer-implemented method of claim 8, wherein the predefined code portions comprise portions of predefined domain specific language code that are independently selectable by the user.

10. The computer-implemented method of claim 8, wherein the predefined code portions are displayed in a predefined area of the third screen for selection by the user, and wherein selection of a predefined code portion from the predefined area serves to populate the input field of the third screen with the selected predefined code portion.

11. The computer-implemented method of claim 8, wherein the predefined code portions are combinable by the user to create a payment methodology capable of determining line level pricing within a claim level pricing scheme.

12. The computer-implemented method of claim 8 further comprising receiving in a library a user-defined payment criterion for defining the payment methodology.

13. The computer-implemented method of claim 12, wherein the user-defined payment criterion is stored in the library, and wherein the user-defined payment criteria is accessible as a predefined code portion via at least one of the first screen, the second screen, the third screen, or a fourth screen of the graphical user interface for subsequent selections by the user for defining the payment methodology.

14. The computer-implemented method of claim 8, wherein the service group selected is associated with a claim level pricing scheme or a line level pricing scheme.

15. An apparatus for pricing claims for reimbursement within a claim pricing software application presented in a graphical user interface, the apparatus comprising at least one processor and at least one memory including computer program code, the at least one memory and the computer program code configured to, with the processor, cause the apparatus to at least:
provide for display of a first screen comprising an input field within a graphical user interface;
receive input from a user via the input field of the first screen comprising data identifying a rate schedule to be used for pricing a claim;
receive a selection from the user of a product;
receive a selection from the user of a service category of the claim;
provide for display of a second screen comprising an input field within the graphical user interface, wherein the input field of the second screen is configured to receive input from the user of criteria to be associated with the selected service category;
receive selection from the user of a service group for the selected service category;
provide for display of a third screen comprising an input field within the graphical user interface based on the service group selected; and
receive input from the user via the input field of the third screen defining a payment methodology of the claims, wherein the input from the user comprises selection of predefined code portions to define a customized payment methodology for pricing the claim.

16. The apparatus of claim 15, wherein the predefined code portions comprise portions of predefined domain specific language code that are independently selectable by the user.

17. The apparatus of claim 15, wherein the predefined code portions are displayed in a predefined area of the third screen for selection by the user, and wherein selection of a predefined code portion from the predefined area serves to populate the input field of the third screen with the selected predefined code portion.

18. The apparatus of claim 15, wherein the predefined code portions are combinable by the user to create a payment methodology capable of determining line level pricing within a claim level pricing scheme.

19. The apparatus of claim 15, wherein the at least one memory and the computer program code are further configured to, with the processor, cause the apparatus to receive in a library a user-defined payment criterion for defining the payment methodology.

20. The apparatus of claim 19, wherein the user-defined payment criterion is stored in the library, and wherein the user-defined payment criteria is accessible as a predefined code portion via at least one of the first screen, the second screen, the third screen, or a fourth screen of the graphical user interface for subsequent selections by the user for defining the payment methodology.
